(19) United States
(12) Patent Application Publication
(10) Pub. No.: US 2015/0164092 A1
(43) Pub. Date: Jun. 18, 2015

(54) FILLING FOR BAKED FOOD PRODUCTS

(71) Applicant: NESTEC S.A., Vevey (CH)

(72) Inventors: Helen Chisholm, Cheseaux (CH); Anwesha Sarkar, Leeds (GB); Sylvie Anthonioz, Lausanne (CH); Judith Arfsten, Gumefens (CH)

(21) Appl. No.: 14/412,862

(22) PCT Filed: Jul. 3, 2013
(86) PCT No.: PCT/EP2013/064021

§ 371 Date: Jan. 5, 2015

(30) Foreign Application Priority Data
Jul. 3, 2012 (EP) 12174811.5

(51) Int. Cl. A21D 13/00

(52) U.S. Cl. CPC A21D 13/0041

(57) ABSTRACT

The invention relates to a filling composition comprising an emulsion comprising from 10 to 40% by weight water and at least 60% by weight oil, wherein the oil is an encapsulated oil comprising an inner core comprising the oil encapsulated in an outer shell of cross-linked proteinaceous material, and a mixture of sugars and/or sugar substitutes. The invention also relates to processes for preparation of the filling composition and its use in composite products.

### TECHNICAL FIELD

The invention relates to the field of filling compositions, more particularly to aqueous based filling compositions suitable for use as filling for baked food products such as wafers, biscuits/cookies, crackers or expanded extruded cereal products, as well as to methods for preparing such a filling composition and to the use of the filling composition as a filling in a food product.

### BACKGROUND OF THE INVENTION

Any discussion of the prior art throughout the specification should in no way be considered as an admission that such prior art is widely known or forms part of common general knowledge in the field.

Lipid based fillings, also known as creams or pralines, are used in a variety of food products, especially in the field of confectionery and bakery applications. Examples are lipid based fillings, include sweet or savory fillings, such as for sandwich biscuits, for wafer products, for crackers, for expanded extruded cereal products, or for cakes. However such lipid based fillings tend to have a nutritional profile high in total fat and high in saturated fats in order to provide the desired organoleptic properties, such as the indulgent, creamy, mouth feel, and textural properties such as a sufficiently firm texture to ensure shape stability of the filling upon handling of the product.

However, high fat content, and particularly of fats containing high levels of saturated fatty acids (SFA), are known to have negative health impacts, for instance related to an enhanced risk for cardiovascular diseases. Hence it would be desirable to reduce total fat content of filling compositions, and to avoid or reduce the content of high SFA solid-type fats, or hydrogenated fats containing significant levels of trans fatty acids.

Aqueous-based fillings are known, such as jam or caramel like fillings, which contain lower levels of fat, even as low as zero fat content. However a drawback of such aqueous-based fillings is that they have a high moisture content. Water activity or a_{w} reflects moisture content of a food product. For instance conventional fruit jam typically has an a_{w} in the range from 0.7 to 0.8. Due to high a_{w}, the moisture transfer from the aqueous based filling to baked flour based products in contact with the filling (e.g. biscuits, wafers, expanded extruded cereal products) is very high. The driving force for this moisture transfer is the difference in water activity between the aqueous based filling and the initially drier baked food product. Therefore, water migrates rapidly from the filling to the baked food product which has a lower water activity, until the water activity equilibrium is attained. Thus conventional aqueous based fillings, such as fruit jams, cannot be used to produce a crispy biscuit since they rapidly “wet” the baked food product in contact with the filling, resulting in a loss of crispiness of the product. As a consequence of the rapid loss of crisp texture, the filled product is not attractive for the consumer and it also has a poor shelf life having a stale taste.

Approaches to lower the a_{w} of aqueous based fillings have been described in the literature. Commonly, in order to avoid sugar crystallisation in the aqueous phase, the water activity of flavoured fillings is lowered by the addition of non-sugar ingredients such as sorbitol, glycerol or other polyhydric alcohols. In another approach EP 372 596 A2 describes cookies made with low a_{w} fibre-containing fillings. The filling has a very low water activity (0.2-0.35) so that crispness of the cookies outer dough is preserved. The filling comprises of a significant amount of glycerine or propylene glycol (at least 16 wt. %) as a humectant which acts to reduce a_{w}. U.S. Pat. No. 4,774,095 describes a flavoured filling for dough-based products comprising an aqueous phase, a sugar dissolved in aqueous phase, a thixotropic cohesive network of cellulosic fibrils or microfibrils, edible polyols as humectant (at least 5 wt. %) and, high methoxy pectin in the form of pectin gel lumps. EP1250051 describes a polyhydric alcohol-free aqueous-based filling comprising a mixture of sugars, comprising fructose, glucose and sucrose, dissolved in the aqueous phase in relative proportions to prevent crystallisation and set water activity value from 0.38 to 0.47, together with favouring and acidifying agents.

However all of the aqueous-based fillings described above still have texture and mouthfeel like a jam or chewy caramel.

Approaches have been made to produce fat-based (fat-continuous) fillings with lower total fat content based on the use of water-in-oil emulsions, stabilised by emulsifiers, which provide reduction of total fat content compared to conventional fat-based fillings due to replacement of part of the fat-phase with an aqueous phase. For example, EP 440 203 discloses an emulsified composition characterized in that it has a structure in which a hydrophilic anhydrous solid material and a water-containing food material independently coexist in oil in a state of fine particles respectively. The hydrophilic anhydrous solid material (25-70%) is one of solid sugars, milk products and starches, the water-containing food material (2-40%) is for example a juice or a milk product, the oil (25-65%) can be cocoa butter, and the emulsified composition can be a centre cream for chocolates. However drawbacks of such water-containing fat-based fillings include the addition of synthetic or artificial emulsifiers and/or other stabilising agents in order to form a stable emulsion; unsatisfactory stability of the emulsions on handling, leading e.g. to loss of product shape or texture, and/or fat leakage; too high a_{w} for use as a filling for baked food products such as wafers, biscuits/cookies, expanded extruded cereal products; and/or limited reduction of fat content achievable.

Accordingly there is an ongoing need to provide filling compositions having lower total fat content and/or lower saturated fat content compared to a traditional fat-based filling composition which are suitable as filling for baked food products. There is further a need for filling compositions having lower total fat content and lower saturated fat content compared to a traditional fat-based filling composition whilst having a texture and organoleptic properties closer to those of a fat-based filling, compared to a conventional aqueous based fillings.

It is an object of the present invention to provide a filling composition which overcome or ameliorate at least one of the disadvantages of the prior art, or to provide a useful alternative.

Is would be advantageous to provide an aqueous based filling composition suitable for flour-based baked food products, having a lower total fat content and/or lower saturated fat content than traditional fat-based fillings, having a melt-in-mouth, creamy or indulgent mouthfeel.

### SUMMARY OF THE INVENTION

There is now provided a filling composition suitable for baked food products comprising:
an emulsion comprising from 10 to 40% by weight water and at least 60% by weight oil, wherein the oil is an encapsulated oil comprising an inner core comprising the oil, encapsulated in an outer shell of cross-linked proteinaceous material;
and a mixture of sugars and/or sugar substitutes.

Advantageously the filling composition provides an indulgent, melt-in-mouth, mouth feel, closer to organoleptic properties and texture of a traditional fat based filling compared to conventional aqueous based fillings, whilst permitting a lower total fat content and lower SFA content compared to traditional fat-based fillings, and has a water activity sufficiently low that the filling is suitable to be used for baked products, such as wafers.

In some preferred embodiments of the invention, the other sugar and/or substitutes may be mono- or di-saccarides such as glucose, sucrose, fructose, lactose, maltose; polyols such as glycerol, sorbitol, erythritol maltitol; soluble fibres, maltodextrins, polydextrose, inulin, or any mixture of more than one thereof.

Preferably, the oil is a food grade oil obtained from plants or animals. Preferred oils include, but are not limited to, olive oil, safflower oil, sunflower oil, fish oil, soy bean oil, soy oil, palm kernel oil, palm oil, coconut oil, hazelnut oil, flaxseed oil, rapeseed oil, primrose oil, linseed oil, corn oil, algae oil, cottonseed oil, essential oils, and any combination thereof. The oil may optionally contain at least one liposoluble compound selected from the group consisting of plant polyphenols, plant sterols, carotenoids, fatty acids, vitamins, aromas, antioxidants, and active ingredients. Preferable antioxidants include ascorbic acid, ascorbyl palmitate, citric acid, rosmarinic extract, BHA, BHT, mixed tocopherols, citric acid and EDTA

The proteinaceous material is preferably a protein selected from the group consisting of whey protein, caseinate, egg albumen, lyzozyme, soy proteins, gluten, rice proteins, corn proteins, potato proteins, pea proteins, lupin proteins, any kind of globular or random coil proteins, and any combination thereof. The protein may also comprises a food-grade salt selected from the group comprising sodium citrate, magnesium citrate, potassium citrate, calcium, phosphate, and any combination thereof.

Preferably, the encapsulated oil capsules have an average size in the range of about 0.1-100 μm.

In another aspect there is provided the use of an emulsion comprising from 10 to 40% by weight water and at least 60% by weight oil, wherein the oil is an encapsulated oil comprising an inner core comprising the oil encapsulated in an outer shell of cross-linked proteinaceous material, for the preparation of a filling composition for baked food products. In some preferred embodiments the filling composition is formed by mixing from 10 to 50% w/w of the emulsion, based on the weight of the filling composition, with a mixture of sugar and/or sugar substitutes.

In further aspects there are provided the use of the filling composition in a composite product, and composite products containing the filling composition. The composite product may be, for instance, a biscuit, cracker, wafer, expanded extruded cereal product or other baked food product comprising the filling composition. In one preferred embodiment the baked food product is a wafer.

In another aspect there is provided a process for the preparation of the filling composition, comprising the steps:
(a) Providing an emulsion comprising from 10 to 40% by weight water and at least 60% by weight oil, wherein the oil is an encapsulated oil comprising an inner core comprising the oil encapsulated in an outer shell of cross-linked proteinaceous material,
(b) Dissolving the mixture of sugar and/or sugar substitutes
(c) Mixing the emulsion and the mixture of sugars and/or sugar substitutes.

In a preferred embodiment the emulsion in step (a) is provided by a process comprising the steps:
(a) preparing an emulsion by homogenization of oil in an aqueous phase comprising a proteinaceous material;
(b) heating the emulsion at 70 to 90° C. for 2 to 30 minutes, preferably 5 to 15 minutes;
(c) concentrating the emulsion by microfiltration or centrifugation or evaporation to reduce the water content of the oil cream to a value in the range of from about 10% to about 40% by weight.

These and other aspects, features and advantages of the invention will become more apparent to those skilled in the art from the detailed description of embodiments of the invention, in connection with the attached drawing.

### BRIEF DESCRIPTION OF THE DRAWINGS

FIG. 1 shows a confocal micrograph of an cross linked emulsion according to an embodiment of the invention.

### DETAILED DESCRIPTION OF THE INVENTION

The inventors of the present invention have surprisingly found that an emulsion of encapsulated oil comprising an inner core of oil encapsulated in an outer shell of cross-linked proteinaceous material can be used to provide aqueous filling compositions having lower fat and lower SFA content than traditional fat-based fillings, and which have pleasant indulgent mouthfeel and sufficiently low water activity to be used in place of traditional fat-based (fat-continuous) fillings in a composite product with a baked food product.

The filling comprises an emulsion comprising from 10 to 40% by weight water and at least 60% by weight oil, wherein the oil is an encapsulated oil comprising an inner core comprising the oil, encapsulated in an outer shell of cross-linked proteinaceous material, together with a mixture of sugars and/or sugar substitutes.

The resultant aqueous based fillings are advantageously surprisingly very stable against oil release (oil leakage), and have good textural and organoleptic properties.

The invention concerns the use of encapsulated oil obtained by an emulsification process. The encapsulated oil comprises an inner core of oil encapsulated in an outer shell of cross-linked proteinaceous material, wherein the encapsulated oil comprises at least 80% by weight oil, and wherein the emulsion of the encapsulated oil comprises from 10 to 40% by weight water and at least 60% by weight oil. The filling is formed by mixing 10 to 50% by weight of the emulsion with a mixture of sugars and/or sugar substitutes.

The encapsulated oils are obtained by known emulsion-based encapsulation technology. The process is based on an oil-in-water emulsion that is treated to induce cross-linking of the proteins situated around the oil droplets in order to obtain an encapsulated oil. The emulsion of encapsulated oil is concentrated to obtain a concentrated emulsion of the encapsulated oil. The concentrating step can be carried out by any commonly known concentrating technique such as vacuum drying, microfiltration, centrifugation etc. Prior to the concentrating step, a step of cross-linking a protein-based emulsifier is applied. This may be a physical treatment, such as heat treatment or high pressure treatment, a chemical treatment, or an enzymatic treatment. The final encapsulated oil usually consists of a liquid vegetable oil that is encapsulated in a matrix material consisting of proteins, and optionally carbohydrates (such as sugars, for instance lactose, glucose, maltodextrin, a starch, cellulose), and optionally further surface active agents, or mixtures thereof. The encapsulation procedure transfers the liquid oil into a solid state with, e.g. a creamy-like texture. Thus, the encapsulation process can be regarded as an oil thickening or oil structuring process.

The oil content of the encapsulated oil globules is preferably at least 60% w/w such as from 70 to 99% w/w. Preferably the encapsulated oil comprises at least 70% w/w, more preferably at least 80% w/w, more preferably at least 80% w/w, such as at least 95% w/w. For instance, in one preferred embodiment the encapsulated oil contains from 80% to 99% w/w oil, encapsulated in an outer shell of cross-linked protein. In a preferred embodiment the encapsulated oil comprises from 85% to 98% w/w, preferably from 90% to 98% w/w oil, such as from 90% to 97% w/w oil.

The oil used for preparing the emulsion can be any vegetable oil or fat that is liquid or that can be liquefied at ambient conditions. The oil is suitably a food grade oil. Examples include sunflower oil, rapeseed oil, olive oil, soy oil, fish oil, canola oil, linseed oil, safflower oil, corn oil, algae oil, cottonseed oil, palm oil, palm kernel oil, coconut oil, grape seed oil, a nut oil such as hazelnut oil, walnut oil, or other nut oil, peanut oil, rice bran oil, sesame oil, cocoa butter, milk fat, or combinations thereof. Optionally, the oil can contain one or more liposoluble compounds; such as for example plant polyphenols, fatty acids, such as n-3 fatty acids, n-6 fatty acids, vitamins, aromas, flavours, antioxidants, other active ingredients. Preferable antioxidants include ascorbic acid, ascorbyl palmitate, citric acid, rosmarinic extract, BHA, BHT, mixed tocopherols, citric acid and EDTA. Preferably, a vegetable oil is used, more preferably an oil with a low SFA content is chosen such as high oleic sunflower oil or high oleic rapeseed oil.

The matrix material that is used to encapsulate the oil is preferably a protein-based emulsifier, and can be any food-grade protein-based emulsifier such as milk and/or whey proteins, soy proteins, pea proteins, caseinate, egg albumen, lyzozyme, gluten, rice protein, corn protein, potato protein, lupin protein, pea protein, skimmed milk proteins or any kind of globular and random coil proteins as well as combinations thereof. The proteins may comprise food grade salts, such as sodium citrate, magnesium citrate, potassium citrate, calcium phosphate or combinations thereof. Such salts may be present in an amount typically up to 10% w/w, preferably from 0 to 5% w/w.

In one preferred embodiment the protein is one or more milk and/or whey derived protein.

Preferred milk proteins or milk protein fractions in accordance with the present invention comprise, for example, whey proteins, α-lactalbumin, ρ-lactalbumin, bovine serum albumin, acid casein, caseinates, α-casein, ρ-casein.

As far as whey proteins are concerned, the protein source may be based on acid whey or sweet whey or mixtures thereof and may include α-lactalbumin and β-lactalbumin in any proportions. The proteins may be intact or at least partially hydrolysed.

Typically the encapsulated oil comprises up to about 30% w/w of the encapsulating protein, preferably up to about 20% w/w protein, more preferably up to about 10% w/w protein. In one preferred embodiment an encapsulated oil according to the invention comprises from about 1% w/w to about 20% w/w of the protein, more preferably from about 2% w/w to about 15% w/w of the protein, such as from about 3% w/w to about 15% w/w of the protein. In another preferred embodiment an encapsulated oil according to the invention comprises from about 3% w/w to about 10% w/w of the protein. In one preferred embodiment an encapsulated oil according to the invention comprises a maximum of 5% w/w of the protein. In another preferred embodiment an encapsulated oil according to the invention comprises a maximum of 4% w/w of the protein. In a further embodiment an encapsulated oil according to the invention comprises a maximum of 3% w/w of the protein.

The single encapsulated oil droplets of encapsulated oil in the oil cream emulsion according to the invention typically have an average diameter in the range of from about 0.1 to 10 μm, for example about 1 to 5 μm. The oil droplets are dispersed in the continuous aqueous phase.

Emulsion based processes to obtain encapsulated oils are well-known in the art and are described in various scientific publications and review articles.

The invention also relates to a process for the preparation of an emulsion of encapsulated oil having a water content of 10-40%, wherein an emulsion is prepared by homogenization of oil with an aqueous protein solution and optionally a food grade salt and/or a liposoluble compound; the protein is then denaturated and cross-linked by a physical treatment, such as heat treatment, UV-radiation or high pressure treatment, a chemical treatment or an enzymatic treatment. Preferably, the emulsion is heat treated at around 80° C. for around 10 minutes to induce denaturation and cross-linking of the protein and then cooled. The emulsion is preferably concentrated by microfiltration or centrifugation or water evaporation (e.g. by vacuum concentration) to a residual water content of about 10 to 40% w/w, preferably about 15% to 35% w/w. The resultant concentrated emulsion of the encapsulated oil has a solid, creamy-like texture and is thus referred to herein also as an “oil cream”.

The concentrated emulsion, “oil cream”, comprises 10 to 40% by weight water and at least 60% by weight oil, wherein the oil is an encapsulated oil as described above comprising an inner core comprising the oil, encapsulated in an outer shell of cross-linked proteinaceous material. In a preferred embodiment the concentrated emulsion comprises maximum 35% w/w water, even more preferably maximum 30% w/w water, such as a maximum 25% w/w water. In one preferred embodiment the concentrated emulsion comprises from 10% to 35% w/w water, preferably from about 10% to about 30% w/w water.

Microscopic analysis shows the oil cream emulsion to exist as discrete droplets of oil encapsulated by the protein material, also referred to as “oil droplets or globules” dispersed in a continuous water phase. The concentrated emulsion of encapsulated oil, “oil cream”, has a solid, creamy-like texture and is surprisingly stable. Oil leakage or phase separation of the emulsion was not observed on storage over 1 month, nor on handling or further processing of the emulsion. Even under the shear stress conditions during the mechanical mixing/whisking used to mix the sugars and/or sugar substitutes with the emulsion for formation of the filling composition.

The oil cream, as described above, exists as a stable emulsion without the need for the addition of any other emulsifier, stabiliser, structuring agent, or other additive. Advantageously this permits fillings compositions according to the invention to be substantially free from added emulsifiers.

The filling composition according to the invention may typically comprise about 5% to 60% w/w, preferably from about 5 to 50% w/w, more preferably from about 5 to 40%, such as from about 10 to 40% w/w, of the “oil cream” concentrated emulsion of encapsulated oil. In some embodiments the filling composition may comprise a maximum of 30% w/w of the oil cream emulsion, such as from 5% to 30% w/w, preferably from 5% to 20% w/w of the emulsion.

The filling composition of the invention further comprises a mixture of sugars and/or sugar substitutes. The sugars may typically be selected from monosaccharides, such as glucose, fructose, and disaccharides such as sucrose, maltose, galactose, or any combination thereof. The term “sugar substitutes” is used herein to encompass ingredients or combinations of ingredients that can be used to replace sugar to provide the desired sweetness, bulk and water activity reduction in the filling composition. Suitable sugar substitutes may typically be selected from polyols, such as glycerol, sorbitol, mannitol or xylitol; maltodextrins; soluble fibres glucose, sucrose, fructose, lactose, maltose polyols such as glycerol, sorbitol, erythritol maltitol, soluble fibres, polydextrose, inulin maltodextrins, or any mixture of more than one thereof.

A mixture of sugars may be used alone, or the sugars may be replaced partially or totally by a sugar substitute or combination of sugar substitutes.

In some embodiments the mixture of sugars and/or sugar substitutes comprises a mixture of sugars and optionally a polyol. In one embodiment the mixture of sugars comprises fructose, glucose and sucrose. In another embodiment the mixture of sugars and or sugar substitutes comprises a sugar and a polyol, for instance fructose and glycerol. In some preferred embodiments the sugar content is replaced partially by one or more sugar substitutes, such as maltodextrins, soluble fibres and optionally polyols, or any combination thereof. In other embodiments the sugar content may be replaced totally by a mixture of sugar substitutes, such as maltodextrins, soluble fibres, polyols or any combination thereof.

The sugars and/or sugar substitutes are added in amounts sufficient to provide the desired sweetening of the filling composition and to reduce the water activity of the filling composition. In a preferred embodiment the mixture of sugars and/or sugar substitutes is present in amounts to provide the filling with a water activity value of lower than 0.60, preferably lower than 0.55, even more preferably lower than 0.50. In a preferred embodiment the mixture of sugars and/or sugar substitutes is present in amounts to set the water activity value in the range of from 0.30 to 0.60, preferable 0.35 to 0.55, such as 0.36 to 0.54.

Water activity or a_{w} is a measurement related to the water content. It is defined as the vapor pressure of a liquid divided by that of pure water at the same temperature; therefore, pure distilled water has a water activity of exactly one. Water activity can be measured according to the AOAC method 978.18 and performed at 25° C., after equilibrium is reached, using a HygroLab instrument from Rotronic. Higher a_{w} substances tend to support more microorganisms that may destroy the product. Bacteria usually require at least 0.91, and fungi at least 0.7. At a_{w} values above 0.65 crunchy products tend to lose their crunchiness.

Typically the filling composition comprises from about 40% to about 90% w/w of the mixture of sugars and/or sugar substitutes. In some preferred embodiments the filling composition comprises from about 50% to about 90% w/w, preferably from about 50% to about 85% w/w, such as from 50% to 80% w/w, such as from 60% to 80% w/w of the mixture of sugars and/or sugar substitutes.

In one preferred embodiment the filling composition comprises from 40 to 90% w/w, preferably from 50% to 80% w/w, of the mixture of sugars and/or sugar substitutes, and from 10% to 60% w/w of the “oil cream” emulsion.

In one embodiment a mixture of sugars and optionally a polyol may be used wherein the filling composition advantageously comprises:

10-55% w/w of fructose; preferably 15-40% w/w of fructose

10-40% w/w of glucose; preferably 20 to 40% w/w of glucose

0-15% w/w of sucrose; preferably 5-10% w/w of sucrose

0-10% w/w of glycerol,

mixed with the “oil cream” emulsion.

Invert sugar, which is an equimolar mixture of fructose and glucose can be used as a source of fructose and glucose. Invert sugar may, for example, be used in the form of a sugar syrup.

The mixture of sugars and/or sugar substitutes is preferably dissolved in the aqueous phase of the “oil cream” emulsion. Saturation of the free water in the “oil cream” emulsion with sugars and/or sugar substitutes makes it possible to reduce the water activity of the filling composition to a suitable water activity in the range desired for significantly reducing moisture transfer with a baked food product, such as a wafer, whilst preventing significant crystallisation of sugars and/or sugar substitutes during storage.

The mixture of sugars and/or sugar substitutes may be dissolved directly in the “oil cream” emulsion, e.g. with heating and agitation. Alternatively the mixture of sugars and/or sugar substitutes may be pre-heated to dissolve the crystals of sugar and/or the sugar substitutes. This heating step may be carried out in the presence of water, such as water content of invert syrup, or of a liquid sugar substitute such as glycerol. The mixture of sugars and/or sugar substitutes is then mixed with the “oil cream”, whereby the sugars and/or sugar substitutes dissolve in the aqueous phase of the emulsion. In this way direct heating of the “oil cream” emulsion can be avoided to minimize oxidative degradation of the oil.

According to one aspect of the present invention a process is provided for preparing a filling composition, comprising:
(a) Providing an emulsion comprising from 10 to 40% by weight water and at least 60% by weight oil, wherein the oil is an encapsulated oil comprising an inner core comprising the oil encapsulated in an outer shell of cross-linked proteinaceous material,
(b) Providing a mixture of sugar and/or sugar substitutes,
(c) Adding the mixture of sugars and/or sugar substitutes to the emulsion with mixing to form a homogeneous mixture.

The mixing of the ingredients can be carried out by conventional mixing methods, for instance using standard industrial mixing apparatus. In a preferred embodiment the mixture of sugars and/or sugar substitutes is dissolved in water before addition to the emulsion.

Advantageously filling compositions of the invention may be easily industrialised using conventional equipment.

Depending on the specific type of filling composition, different types of ingredients may be supplemented to the filling composition.

For instance typical filling compositions for confectionery products may further comprise other supplementary ingredients such as milk powder, whey powder, fruit acids, cocoa powder, natural or synthetic flavors, natural or artificial colors, starch based fillers, emulsifiers such as lecithin, and other ingredients.

In some embodiments the filling contains cocoa powder in an amount from 1 to 30% w/w, such as from about 1 to 20% w/w, for instance around 1 to 10% w/w cocoa powder.

The filling composition is an aqueous-based filling, with the encapsulated oil dispersed in the water phase of the emulsion.

The fat content and SFA content of the filling composition of the invention can be significantly reduced compared to traditional fat-based fillings. In some embodiments the filling composition may have a total fat content in the range of from about 5 to 40% (w/w). In preferred embodiments the filling composition has a total fat content in the range of from about 5 to about 30% w/w, preferably 5 to 25% w/w, more preferably 5 to 20% w/w by weight of the filling composition. The amount of fat may vary depending on the type of product.

Without being bound by any theory it is believed that the pleasant, indulgent mouth feel of the fillings of the invention is due to the encapsulated oil, wherein the oil is in a liquid state as oil droplets encapsulated by the cross-linked protein, whereby, on biting the filling, liquid oil is released into the mouth on breaking of the encapsulating protein shell, giving a melt-in-mouth, indulgent mouthfeel.

The filling compositions of the invention can provide a smooth, homogenous, creamy-like texture and with sufficient structural stability on handling, desired for fillings for baked food products such as wafers, biscuits or expanded extruded cereal products.

Advantageously the a_{w} of the filling compositions can be set at a value sufficiently low to permit the use of the filling with flour-based baked food products such as wafers, expanded extruded cereal products, or biscuits/cookies. Advantageously a_{w} values of the filling composition may be less than 0.55, preferably less than 0.50. Filling compositions can be provided with a_{w} even lower than 0.40, such as a_{w} from 0.36.

According to another aspect there is provided a composite product comprising the filling composition according to the invention. The composite product may be a flour based baked food product, such as a biscuit/cookie, cracker, wafer, or expanded extruded cereal product, or a combination thereof, comprising the filling composition of the invention as a filling or as a topping. In one preferred embodiment the composite product is a wafer product comprising the filling composition as a filling sandwiched between two, or more, layers of wafer.

Typically the filling composition may represent from about 10 to 80% w/w of the composite product, such as from about 20 to 50% w/w.

In the present context the term “filling composition” relates to a pre-prepared composition to be used as one part of a composite product. The filling and the other part(s) of the composite product are composed of different components. Preferably, the filling is surrounded by the other part(s) of the composite product.

Expanded extruded cereal products are made from starch-based extrudable dough which may be cooked in a single or a twin-screw extruder under high temperature, and which is then extruded through a die. Extrusion through a die may be accompanied by expansion, depending on the water content of the dough and depending on the pressure at the die. The product may then be cut and/or further processed and cooled. Such products are discussed in the text book “Extrusion Cooking, Technologies and Applications”, edited by Robin Guy, Woodhead Publishing, (2001) and an example of such a product is Nestle Bocaditos as sold in Mexico.

Wafers are baked products which are made from wafer batter and have crisp, brittle and fragile consistency. Wafers are manufactured by preparing a batter containing mainly flour and water to which other minor ingredients may be added. A batter for use in the manufacture of commercial flat wafers typically contains 40 to 50% flour. Common formulations may also comprise at least one of the following ingredients: fat and/or oil, lecithin and/or emulsifiers, sugar, whole egg, salt, sodium bicarbonate, ammonium bicarbonate, skim milk powder, soy flour, yeast, and/or enzymes such as xylanases or proteases, for example.

Biscuits/cookies are usually baked out of dough. Common biscuit dough formulations comprise flour, sugar, fat, salt, water, milk, baking powder, for example.

As used in the specification, the words “comprise”, “comprising” and the like are to be construed in an inclusive sense as opposed to an exclusive or exhaustive sense; that is to say, in the sense of “including, but not limited to”.

As used in the specification, the word “about” should be understood to apply to each bound in a range of numerals. Moreover, all numerical ranges should be understood to include each whole integer within the range.

As used in the specification, the singular forms “a”, “an”, and “the” include plural referents unless the context clearly dictates otherwise.

As used in the specification, the term “substantially free” means that no more than about 1 weight percent of the excluded material is present. In a preferred embodiment, “substantially free” means that no more than about 0.1 weight percent of the excluded material remains. “Entirely free” typically means that at most only trace amount of the excluded material is present, and preferably, no detectable amount is present. Conversely, “substantially all” typically means that at least about 90 weight percent, preferably at least about 95 weight percent, and more preferably at least about 99 weight percent of the material is present.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

It should be noted that embodiments and features described in the context of one of the aspects or embodiments of the present invention also apply to the other aspects of the invention.

The invention is further described with reference to the following non-limiting examples.

### EXAMPLES

### Example 1

### Preparation of an Emulsion of Encapsulated Oil

Emulsion Preparation

High oleic sunflower oil was emulsified in an aqueous solution of 4% (w/w) WPI (whey protein isolate) for the samples 1a and 1b. The final emulsion contained 50% (w/w) of sunflower oil, 2% (w/w) WPI and 48% (w/w) water. For the sample 2, sunflower oil was emulsified in an aqueous solution of 8% (w/w) WPI. The final emulsion contained 50% (w/w) sunflower oil, 4% (w/w) WPI and 46% (w/w) water. The emulsification was carried out with a high pressure homogenizer. The parameters are adapted to reach an average oil droplet size between 0.5 microns and 5 microns.

Thermal Crosslinking:

The emulsion was heat treated at 80° C. for 10 min to achieve a cross-linking of the protein layer which surrounds the oil droplets in the emulsion. The crosslinked emulsion is cooled down to ambient temperature.

Concentration Process

The emulsion was concentrated under vacuum (50 mbar) at 35° C. using an rotating vacuum evaporator (Inox-Glatt20) to produce the concentrated emulsion of encapsulated oil (“oil cream”) with a water content around 25% wt. Per hour about 1-2 l of water were evaporated. In 1b (see table 1) a further step of concentration under vacuum was carried to further reduce water content. The composition of the resulting emulsions is shown in Table 1 below:

TABLE 1

| Sample No. | Moisture % (w/w) | Protein:Oil Ratio (w/w) |
|---|---|---|
| 1a | 28.5 | 4:100 |
| 1b | 15 | 4:100 |
| 2 | 21.5 | 8:100 |

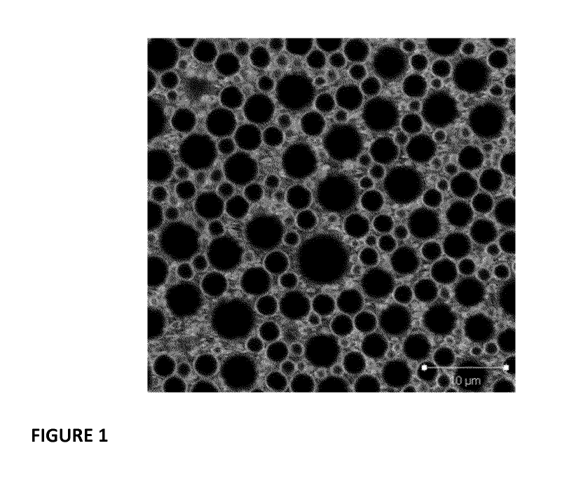

The resulting emulsions are observed to exist as stable oil in water emulsions. FIG. 1 shows a confocal micrograph of the cross linked emulsion according to sample 1a, whereby the protein (appearing in grey) is visible surrounding the oil droplets (appearing in black). Scale bar is 10 μm.

### Example 2

### Preparation of Sample Fillings

Table 2 below shows the composition of example fillings prepared using the emulsions prepared according to example 1, together with two comparative fillings prepared with sunflower oil (liquid oil) “comp.1” and palm kernel oil (high SFA fat) “comp.2” respectively, in place of the emulsion of encapsulated oil. In the comparative examples whey protein isolate (WPI) was used added as emulsifier. The Invert sugar used in the examples has the composition 34% water, 32% fructose, 32% glucose w/w.

All amounts shown in Table 2 below are % w/w based on total weight of the filling, with the exception of the a_{w} value.

| Sample | 1 | 2 | 3 | 4 | 5 | 6 | Comp. 1 | Comp. 2 |
|---|---|---|---|---|---|---|---|---|
| Emulsion 1a | 36 | 36 | 18 | | | | | |
| Emulsion 1b | | | | 33 | | 50 | | |
| Emulsion 2 | | | | | 18 | | | |
| Fructose | 55 | 24 | 32 | 20 | 32 | 17 | 27.31 | 27.31 |
| Glucose | | 24 | 32 | 22 | 32 | 18 | 27.36 | 27.36 |
| Invert syrup | | | 11.6 | 15 | 11.6 | 7.5 | 26.5 | 26.5 |
| Sucrose | | 7 | 6.4 | 10 | 6.4 | 7.5 | 6 | 6 |
| Glycerol | 9 | 9 | | | | | | |
| Sunflower Oil | | | | | | | 12.34 | |
| Palm Kernel Oil | | | | | | | | 12.34 |
| WPI | | | | | | | 0.49 | 0.49 |
| Total fat | 24.68 | 24.68 | 12.34 | 22.62 | 12.34 | 34.27 | 12.34 | 12.34 |
| a_{w} | 0.51 | 0.53 | 0.37 | 0.44 | 0.36 | 0.36 | 0.33 | 0.35 |

All recipes were prepared by cooking the sugar mixture, and polyol where used, in a saucepan at a temperature up to about 140° C. to 150° C. until the powder ingredients melted and dissolved and a clear syrup was obtained. The syrup was then combined with the oil cream in a Hobart mixer with a balloon whisk attachment and whipped in the Hobart until it was homogeneous.

The fillings obtained using the emulsions of Example 1 have sufficiently low a_{w} suitable for use with baked food products, and were observed to have a pleasant, indulgent mouthfeel.

The fillings containing the emulsions of example 1 had a stable, homogenous, non-grainy texture, and no oil leakage was observed from the filling compositions of samples 1-6. Even at low content of encapsulating cross-linked protein (samples 1-4 and 6) the emulsion was stable to oil leakage. On preparation, handling and storage no oil leakage was observed. On the contrary the fillings of comparative examples comp.1 and comp.2, prepared using sunflower oil and palm kernel oil respectively were unstable and oil leakage was observed immediately

A wafer sandwich product was prepared using the filling composition of sample 3 as filling. It was observed by sensory analysis that the wafer remained crisp in contact with the filling. The samples were tasted the day after preparation and 2 weeks later and found to be crispy with good sensory properties. Moreover the filling had a water activity of 0.37 which is well below the limit of 0.55 to maintain a crisp wafer therefore there will be no transfer of moisture from the filling and the product should remain crisp for the duration of shelflife.

Although certain preferred embodiments have been disclosed in the description with reference to specific examples, it will be recognised that the invention is not limited to the preferred embodiments. Various modifications may become apparent to those of ordinary skill in the art and may be acquired from practice of the invention. It will be understood that the materials used and the chemical details may be slightly different or modified from the descriptions without departing from the methods and compositions disclosed and taught by the present invention.

1. A filling composition for baked food products comprising:
an emulsion comprising from 10 to 40% by weight water and at least 60% by weight oil, wherein the oil is an encapsulated oil comprising an inner core comprising the oil encapsulated in an outer shell of cross-linked proteinaceous material; and
a mixture of sugars and/or sugar substitutes.

2. A filling composition according to claim 1, wherein the encapsulated oil comprises at least 60% by weight oil.

3. A filling composition according to claim 1, wherein the protein comprises at least one food-grade protein.

4. A filling composition according to claim 1, wherein the outer shell comprises cross-linked protein and a carbohydrate.

5. A filling composition according to claim 1, wherein the oil is selected from the group consisting of olive oil, safflower oil, sunflower oil, fish oil, soy bean oil, soy oil, palm kernel oil, palm oil, coconut oil, flaxseed oil, rapeseed oil, primrose oil, linseed oil, corn oil, grape seed oil, nut oil, rice bran oil, sesame oil, peanut oil, cottonseed oil, and combinations thereof.

6. A filling composition according to claim 1, wherein the emulsion comprises from 15 to 35% by weight of water.

7. A filling composition according to claim 1, wherein the mixture of sugars and/or sugar substitutes is present in an amount sufficient to provide a water activity value of less than 0.60.

8. A filling composition according to claim 1 having a water activity value of from 0.30 to 0.60.

9. A filling composition according to claim 1 comprising from 40 to 90% by weight of the mixture of sugars and/or sugar substitutes, and from 10 to 60% of the emulsion.

10. A filling composition according to claim 1, wherein the mixture of sugars and/or sugar substitutes comprises glucose and sucrose.

11. A filling composition according to claim 1, wherein the filling composition comprises one or more sugar substitutes selected from group consisting of polyols, soluble fibres, maltodextrins glucose, sucrose, fructose, lactose, maltose polyols such as glycerol, sorbitol, erythritol maltitol, soluble fibres, polydextrose, inulin maltodextrins, and any mixture of more than one.

12. A method for the preparation of a baked food product comprising preparing an emulsion comprising from 10 to 40% by weight water and at least 60% by weight oil, wherein the oil is an encapsulated oil comprising an inner core comprising the oil encapsulated in an outer shell of cross-linked proteinaceous material and filling the baked food with the emulsion.

13. Method according to claim 12 wherein the filling composition is formed by mixing from 10 to 60% w/w of the emulsion, based on the weight of the filling composition, with a mixture of sugar and/or sugar substitutes

14. Use according to claim 13 wherein the mixture of sugars and/or sugar substitutes is present in an amount sufficient to provide a water activity value of lower than 0.70.

15. Use according to claim 13, wherein the amount of mixture of sugars and/or sugar substitutes in the filling composition is from 10 to 90% w/w.

16. A process for the preparation of a filling composition comprising the steps:
providing an emulsion comprising from 10 to 40% by weight water and at least 60% by weight oil, wherein the oil is an encapsulated oil comprising an inner core comprising the oil encapsulated in an outer shell of cross-linked proteinaceous material;
providing a mixture of sugar and/or sugar substitutes; and
mixing the emulsion and the mixture of sugars and/or sugar substitutes to provide a homogenous mixture.

17. A process according to claim 16, wherein the emulsion step is prepared by a process comprising the steps:
preparing an emulsion by homogenization of oil in an aqueous phase comprising a proteinaceous material;
heating the emulsion at 70 to 90° C. for 2 to 30 minutes; and
concentrating the emulsion by microfiltration or centrifugation or evaporation to reduce the water content of the oil cream to a value in the range of from about 10% to about 40% by weight.

18. A process according to claim 16, wherein the mixture of sugars and/or sugar substitutes is heated in the presence of water to dissolve the sugars and/or sugar substitutes.

19. A composite food product comprising a flour based baked food product and a filling composition for baked food products comprising:
an emulsion comprising from 10 to 40% by weight water and at least 60% by weight oil, wherein the oil is an encapsulated oil comprising an inner core comprising the oil encapsulated in an outer shell of cross-linked proteinaceous material; and
a mixture of sugars and/or sugar substitutes.

20. A composite food product according to claim 19 wherein the flour based baked food product is selected from the group consisting of wafer, biscuit and expanded extruded cereal products.

21. A composite food product according to claim 19, wherein the ratio of the filling part to the flour based baked food product part is from about 10:90 to about 40:60, based on the weight of the composite food product.
